(19) United States
(12) Patent Application Publication
(10) Pub. No.: US 2008/0131860 A1
(43) Pub. Date: Jun. 5, 2008

(54) SECURITY AND TAMPER RESISTANCE FOR HIGH STAKES ONLINE TESTING

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,334

(22) Filed: Sep. 6, 2007

Related U.S. Application Data
(60) Provisional application No. 60/824,750, filed on Sep. 6, 2006.
(60) Provisional application No. 60/945,875, filed on Jun. 22, 2007.

(51) Int. Cl. G09B 5/08; G09C 1/00

(52) U.S. Cl. 434/350; 380/255

(57) ABSTRACT

In a computing environment, including an educational management system having a server, a method for administering a high-stakes exam includes securing at least one computing device having a processor and memory on which the high-stakes exam is to be administered by controlling the processor's access to the memory, verifying at least one aspect of the environment in which the high-stakes exam is to be administered, and administering the high-stakes exam on the computing device.

### CROSS-REFERENCE TO RELATED APPLICATIONS

This application claims priority to Provisional Application Ser. No. 60/824,750, filed Sep. 6, 2007 and Provisional Application Ser. No. 60/945,875, filed Jun. 22, 2007, which applications are incorporated herein by specific reference.

### BACKGROUND OF THE INVENTION

1. The Field of the Invention

The invention generally relates to methods and systems for distributing educational content, and more particularly to systems and methods for distributing and administering high-stakes exams.

2. The Relevant Technology

Web-based learning management systems (LMS) and content management systems (CMS) have been increasingly used by corporations, government agencies, and higher education institutions as effective and efficient learning tools. An LMS is a software package that facilitates the management and delivery of online content to learners, often in order to enable the individualized and flexible access to learning content. Typically, an LMS allows for an online teaching environment, where a CMS is a computer software system that is typically used to manage the storing, controlling, versioning, and publishing of the educational content. Using a combination of the above technologies, several educational systems have been developed in the art that offer flexible online learning solutions for educators.

Due to the flexible and individualized nature of the systems, users and employees can take courses on their own time and at their own pace, in accordance with their various daily commitments, while educators, management, and human resource departments are able to track progress. Further, because the systems may be easily updated and modified, the systems often provide more relevant information than is currently available using traditional teaching tools.

One advantage of these courses is the ability to give users information they need outside the confines of the traditional university buildings or classrooms. For example, distance learning users can gain access to the course materials by connecting to the Internet or other global network. Thus, several institutions have implemented online or hybrid courses where the course is administered wholly or partially on computing devices in the online setting.

While course materials may be distributed in the online setting, it may be difficult to securely administer high-stakes online examinations. High-stake exams may include such examinations as college and postgraduate entrance examinations, certification examinations, final examinations or other examinations on which the examinees are highly motivated to perform at a high level because of the stakes involved.

In the past, examinees have gone to a proctor-controlled environment, where the exams are administered on paper after which they are collected, scanned in, and graded. In a distributed learning system, proctoring centrally-controlled examinations may be difficult due to the general lack of control exercised on computing devices used to complete online courses and the cost associated with providing additional computing devices specifically for testing. Some issues may include users attempting to crack the exam or share the exams, and/or validate the results not only for themselves, but others as well. For example, some users may attempt to subrogate security measures by loading screen grabbers, key stroke recorders, or other capturing mechanisms.

### BRIEF SUMMARY OF THE INVENTION

In a computing environment, including an educational management system having a server, a method for administering a high-stakes exam includes securing at least one computing device having a processor and memory on which the high-stakes exam is to be administered by controlling the processor's access to the memory, verifying at least one aspect of the environment in which the high-stakes exam is to be administered, and administering the high-stakes exam on the computing device.

In another example, a method for administering high-stakes exams includes encrypting the high-stakes exam to form an encrypted high-stakes exam and at least one key for decrypting the encrypted high-stakes exam, distributing the encrypted high-stakes exam to a computing device to the educational management system, and verifying at least one aspect of an environment in which the computing device is to administer the high-stakes exam, and distributing the key to the computing device.

In yet another example, a system for distributing and administering high-stakes exams in a computing environment includes an educational management system including a server and a database, the educational management system being configured to distribute high-stakes exams a plurality of computing devices, and a plurality of computing devices security features, the computing device security features being configured to control the operation of a computing device to secure the computing devices to prevent the computing devices from accessing unauthorized programs. The educational management system is configured to distribute the high-stakes exams to the computing devices, wherein the high-stakes exams are administered at least partially on the computing devices.

These and other aspects of the present invention along with additional features and advantages will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating a learning system platform for distributing and administering high-stakes exams according to one example;

FIG. 2 is a flowchart illustrating a method of distributing and administering high-stakes exams according to one example;

FIG. 3 illustrates a cryptographic envelope according to one example; and

FIG. 4 is a schematic diagram of a computing device and a security feature according to one example.

### DETAILED DESCRIPTION OF THE VARIOUS EMBODIMENTS

Methods and systems are provided herein for distributing educational content, and more particularly for distributing and administering high-stakes exams. One method includes encrypting a high-stakes exam to form an encrypted high-stakes exam and a key or keys for decrypting the high stakes exam. The encrypted high-stakes exam may then be distributed to the users. The encryption applied to the high-stakes exam may reduce the likelihood that a user will be able to make use of the encrypted high-stakes exam before or after the user has the corresponding key.

In addition to encrypting high-stakes exams, a method may include providing steps for establishing a secure environment on a computing device on which a high-stakes exam is to be administered. In particular, one or more computing device security feature may be used to secure a computing device. The computing device security features may include memory devices with software stored thereon. The software may be used to operate the computing device instead of running the software residing on the computing device. Administrators may be able to readily control which software is on the security feature. Accordingly, by using the software on the security feature to run the computing device, administrators may therefore be able to secure the operation of the computing device, regardless of which programs were previously loaded onto the device, including programs for cheating and/or helping others to cheat on the high-stakes exam.

Systems and methods are also provided for verifying various aspects regarding the exam environment or the environment associated with the administration of the high-stakes exam. Any number of aspects may be verified to establish trust between the computing device environment and an educational management system. The elements may include the configuration of the computing device and in particular that the computing device has been secured. Other elements of the administration may include a verification that the test is being administered in the right location, such as by verifying a network connection either implicitly or explicitly. Implicitly verifying a network connection may include providing the exam on a local area network or local wireless connection in which the user is able to take the exam while in communication with the network. Explicitly verifying the network connection may include a verification of a machine address or other identifier unique to a network or network location. In addition to verifying details regarding the computing device and/or its location, systems and methods may also be provided for verifying the identity of the user taking the high-stakes exam. For example, one or more characteristics unique to each user, such as fingerprints or other characteristic may be ascertained before the exam and then verified at the time of exam.

Systems and methods are also discussed for providing the key to the controlled and verified environment to unlock the encrypted high-stakes exam. The high-stakes exam may then be administered with increased confidence that the high-stakes exam results will remain valid because of the likelihood that a user will not have been able to cheat or help others cheat in the future by accessing programs on the computing device.

As used herein, the term “user” may be used to describe students, employees, content providers, educators, employers, or course administrators who are accessing the education management system using a computer. The computer may be any general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

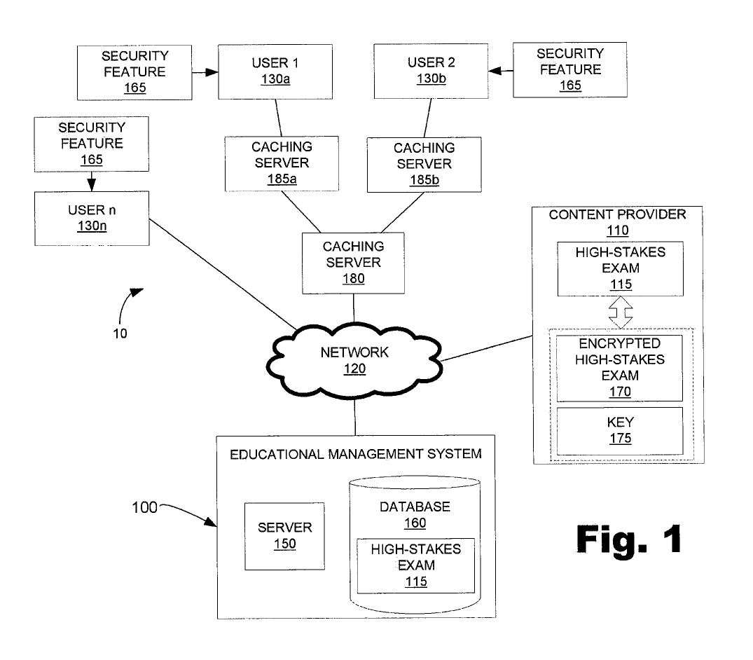

FIG. 1 is a block diagram of a distributed learning platform system 10 that includes an educational management system 100 according to one example. The educational management system stores one or more high-stakes exams 115 and distributes the exams 115 over a network 120 to a number of users, “User 1” 130a through “User n” 130n, who are connected to the educational management system 100.

For ease of reference, a network connection will be discussed incorporating a single exam. Other connections may be used to access the high-stakes exam 115 or establish a connection with the users 130a-n. As will be understood by one of ordinary skill in the art, the network 120 may be any local or global network, including a LAN, WAN, wireless network, internet connection, and the like.

In at least one example, the education management system 100 includes a server 150 capable of sending and receiving communications and data via the network 120, along with a database 160 capable of storing a plurality of educational software, programs, and data, including the high-stakes exam 115. In addition, the database 160 can be used to store data relating to the user identification. As will be understood by one of ordinary skill in the art, any number of configurations may be used to create an education system, including systems using a series of interconnected databases, computers, and servers.

The high-stakes exam 115 may be administered at various locations in a device-secured manner, as will be discussed in more detail below. All types of educational content may be used in a similar manner as described below. Here, the content provider 110 may be a third party who is responsible for creating the high-stakes exams 115, such as a public education system, a private testing company, and/or a certifying agency or company.

One example of distribution of the high-stakes exam 115 will be discussed in more detail below with reference to an encrypted high-stakes exam. The high-stakes exam 115 may be distributed in any suitable manner to the users 130a-n. In many examples, in addition to providing for the distribution of the high-stakes exam 115, the present system is also configured to secure the operation of the computing devices used by each of the users 130a-n. In particular, the distributed learning platform system 10 may also include one or more security feature, referred to herein after as a security feature 165.

The distributed learning platform 10 further includes a security feature 165. The security feature 165 secures computing devices being used by one or more of the users 130a-n taking the high-stakes exam. All types of computing devices may be secured including computing devices which the distributing learning platform system 10 exercises control over, computing devices that are provided to the users as part of the distributed learning platform system and which remain in the user's possession and/or computing devices users obtain independently. The distributed learning platform system may exercise control over computing devices by periodically synching the computing device with the educational management system 100, which in turn may exercise control over which programs are allowed to run on the computing device. Still other computing devices may be secured and used to take high-stakes exams using the distributed learning platform system 10, including devices which the user provides and over which the user may generally exercises control.

The computing device security features may include memory devices with software stored thereon. The software may be used to operate the computing device instead of running the software residing on the computing device. Administrators may be able readily control which software is on the security feature. Accordingly, by using the software on the security feature to run the computing device, administrators may therefore be able to secure the operation of the computing device, regardless of which programs were previously loaded onto the device, including programs for cheating and/or helping others to cheat on the high-stakes exam.

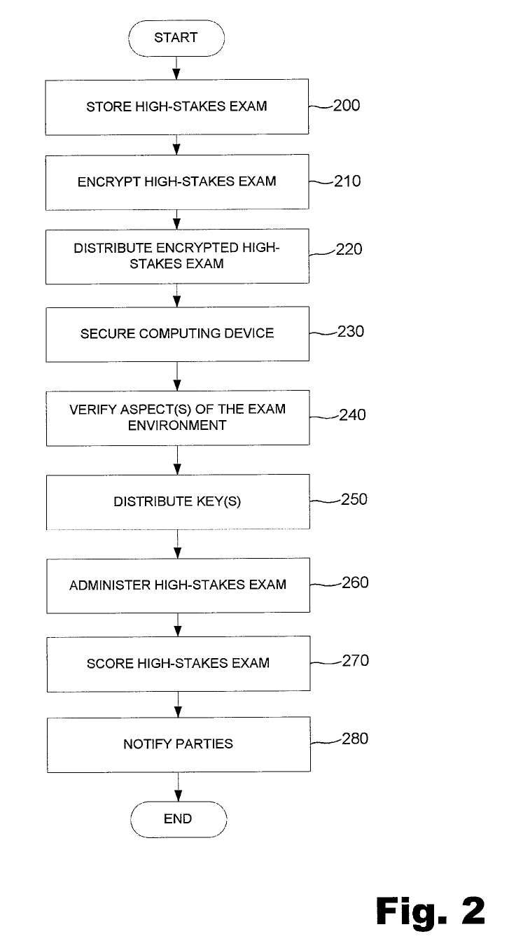

One method of distributing and administering a high-stakes exam will now be discussed with reference to FIG. 2 and continuing reference to FIG. 1. FIG. 2 is a flowchart illustrating a method of distributing a high-stakes exam according to one example. By way of introduction, the method may include the steps of storing one or more high stakes exam at 200, encrypting the high-stakes exam at step 210, distributing the encrypted high-stakes exam at step 220, managing and securing the configuration of computing devices on which the high-stakes exam is to be administered at step 230, verifying one or more aspect of the exam environment at step 240, distributing keys to the users at step 250, administering the high-stakes exam at step 260, scoring the high-<stakes exam at step 270, and notifying the appropriate parties at step 280.

Referring to both FIGS. 1 and 2, at step 200, a high-stakes exam is stored on the educational management system 100. The high-stakes exam 115 may be created by a content provider 110, at the educational management system or elsewhere, and is transmitted to the educational management system 100 via the network 120.

Next, at step 210, the educational management system 100 encrypts the high-stakes exam 115 to form an encrypted high-stakes exam 170 and one or more associated key 175. The high-stakes exam 170 and key 175 are illustrated at both the content provider 110 and the educational management system 100 to emphasize that the high-stakes exam may be encrypted at either or both locations. It may be desirable to increase the security of transmitting the high-stakes exam 115 by sending the encrypted high-stakes exam 170 and/or the key 175 over one or more secure channels. It should be noted that the encrypted high-stakes exam 170 and/or the key 175 may be sent over unsecured channels as well. If the education management system 100 receives the high-stakes exam 115 from the content provider 110 in an unencrypted format, step 210 of encrypting the high-stakes exam will be performed first, after which step 200 in which educational management system stores encrypted high-stakes exam 170 and the key 175 on the database 160 of the educational management system 100.

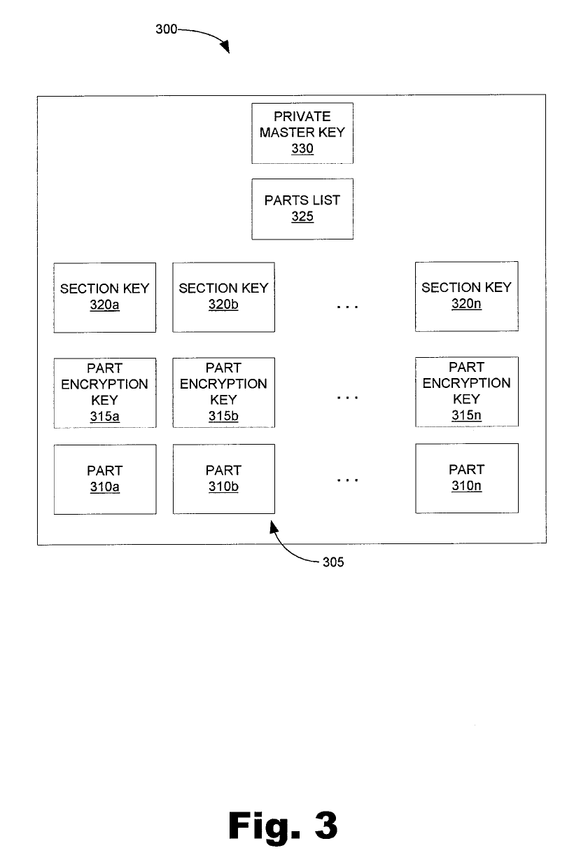

In one example, the step of encrypting the high-stakes exam 115 includes the use of a cryptographic envelope, also referred to as a cryptolope. In particular, the high-stakes exam 115 may be encrypted by packing the high-stakes exam into a container, such as a .ZIP file, to form a cryptolope 300, which is illustrated in FIG. 3. Further, the educational content may be encrypted using a format based on standards reviewed by experts in the field, such as through the use of XML Encryption standard to provide metadata, encryption, and signatures. The educational content may include any number of smaller parts, such as course material related to course objectives or to portions of the course objectives. The educational content may be compressed using standard data compression, such as through the of the .ZIP file format to combine multiple file streams associated with the smaller parts in the educational content into a single file.

When the high-stakes exam 115 (FIG. 1) is packed into the cryptolope 300, the high-stakes exam 115 may be divided into any number of parts 310 a-n. Part encryption keys 315 a-n are then generated, each of which are used to encrypt a corresponding part 310 a-n of the educational content. The part encryption keys 315 a-n are then further encrypted using one or more section keys 320 a-n.

Different encryption keys 315 a-n may be encrypted with different section keys 320 a-n. In particular, separate section keys may be used to encrypt selected parts, which may include different versions of the high-stakes exam 115. Accordingly, multiple versions of the same high-stakes exam may be included as different parts 310a-n. For example, the encrypted high-stakes exam 170 may include versions of a high-stakes exam with the same questions, but which are numbered differently. Providing different section keys to each computing device, such as by providing different section keys with each security feature 165 may allow for the convenient administration of different versions of the same test while minimizing the possibility that users will be able to make unauthorized use of the various versions of the high-stakes exam 170 (FIG. 1).

Regardless of whether multiple versions of a high-stakes exam 115 are encrypted, the master and section keys may be used to allow a user to access the high-stakes exam 115. In addition to encrypting the parts 310 a-n, a parts list 325 is created. The parts list 325 may then be encrypted using a master key 330. The master key 330 provides a key for decrypting the parts list 325. In another example, parts of the high-stakes exam 115 may be included in the cryptolope 300 unencrypted. Part encryption keys 315 a-n are not generated for those parts.

Referring to FIGS. 1 and 2, the educational management system 100 may then distribute the encrypted high-stakes exam at step 220. In one example, the educational management system 100 begins distribution of the high-stakes exam 115 by sending the encrypted high-stakes exam to caching servers 180a-b, which may in turn distribute the encrypted high-stakes exam 170 to other caching servers, such as caching servers 185a-b. While one configuration is illustrated, any number of caching servers may be utilized, including any number of levels of caching servers, to provide access to the educational content from distributed sources to the users 130a-n. Further, the encrypted high-stakes exam 170 may be distributed without the use of caching servers.

The use of the caching servers 180, 185a-b may allow the educational management system 100 to distribute content, including the high-stakes exams 115, in an efficient manner. In particular, users 130a-n may access the caching servers 185a-b as primary access points, rather than accessing the educational management server 150 directly. The caching server 185 may communicate with the educational management server 150 when bandwidth is available, thereby decreasing congestion which would be associated with each user contacting the educational management server 150 directly. Accordingly, high-stakes exams and/or results may be sent and received by the caching servers 185a-b over a period of time.

Such a method of distribution may be capable of distributing large amounts of data widely without requiring the content provider 110 or server 150 to incur the large costs of hardware, hosting, and bandwidth resources that would otherwise be required to distribute the educational content. A scheduled transmission can populate the caching servers 180, 185 a-b with encrypted high-stakes exams 170 over a controlled distribution.

When the encrypted high-stakes exam 170 is stored on the caching servers 185a-b, the encrypted high-stakes exam 170 may be accessible to any number of users. The encryption may allow the system 10 to reduce the unauthorized, undesired, and/or unintended use of the encrypted high-stakes exam 170 by parties whom administrators and/or the content provider 110 wish to prevent from using the encrypted high-stakes exam 170. In particular, while a user may be able to download the encrypted high-stakes exam 170 from the caching servers 185a-b, in its encrypted format, the encrypted high-stakes exam 170 may display as a useless combination of characters.

Accordingly, the key 175 may be provided to intended users 130a-n to allow the users to use the encrypted high-stakes exam 170. In one example, the key 175 may be delivered with the security feature 165. Delivering the key 175 with the security feature 165 may allow the distributed learning platform system 10 to secure a computing device before the key 175 may be used to decrypt the encrypted high-stakes exam 170. Once the security feature 165 has secured the computing device, the key 175 may be used to decrypt the encrypted high-stakes exam 170 to allow the access to take the high-stakes exam 110 in a controlled manner.

If the encrypted high-stakes exam 170 is sent over the network 120 on an unsecured channel, it may be possible for unintended parties to intercept the encrypted high-stakes exam 170. However, as previously discussed, the security measures applied to the encrypted high-stakes exam 170 may reduce the possibilities that an intercepting party will be able to use the encrypted high-stakes exam 170 without the key 175.

Further, the encryption applied to the encrypted high-stakes exam 170 may prevent the likelihood that a user will be able to access the encrypted high-stakes exam 170 before the user receives the key 175. Accordingly, step 220 may further include distributing the encrypted high-stakes exam 170 to the user. In addition to distributing the encrypted high-stakes exam 170 through the use of caching servers 180 and 185a-b, the educational management system 100 may also distribute the encrypted high-stakes exam 170 over the network 120 without the use of the caching servers 180, 185a-b.

The present method at step 230 also includes securing each computing device on which the exam will be administered. In one example, the computing device security feature 165 may be used to secure the computing devices. The computing devices on which the exam is administered may include devices that are physically maintained at the exam location or computing devices which the users bring with them to the exam. Computing devices brought by the user may include computing devices issued to the student as part of the distributed educational platform system 10, which are issued by another authority or system, or computing devices which the students have independently obtained. Each of these computing devices may be secured using a security feature 165, such as a boot-up control feature.

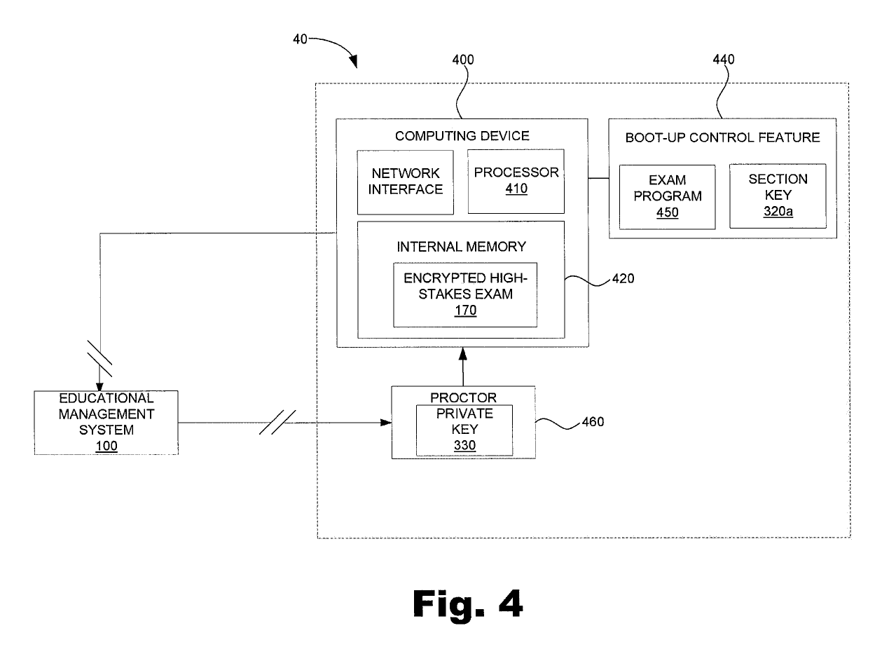

FIG. 4 illustrates an exam environment 40 in which a computing device 400 is used to take a high-stakes exam. The computing device 400 may include a processor 410 and internal memory 420. The internal memory may be a hard drive or other internal memory. The computing device 400 may also include one or more network interface 430 which allows the computing device to interact with one or more networks.

FIG. 4 illustrates a boot-up control feature 440, which is one example of a security feature 165 (FIG. 1). The boot-up control feature 440 may include, without limitation, devices with supplemental memory. Such supplemental memory devices may include USB drives, smart drive, optical storage media, magnetic storage media including one or more additional hard drive, and/or combinations thereof. The boot-up control feature 440 may be configured to prevent the computing device 400 from loading other programs than those residing on the boot-up control feature 440. In particular it may prevent access to internal memory 420.

The boot-up control feature 440 may have an exam program 450 residing thereon which may include an operating system and other software for administering the exam. In one example, the processor 410 loads the exam program 450 rather than booting the computing device 400 using internal memory 420. The exam program 450 may further include instructions for limiting or preventing the processor 410 from loading programs from the internal memory 420 while allowing the processor 410 to retrieve information designated by the exam module 450, such as an encrypted high-stakes exam 170, which may be stored on internal memory 420. Such a configuration may reduce the likelihood that a user has loaded software for cheating or for copying or otherwise making unauthorized use of the high-stakes exam 115 (FIG. 1). In at least one additional example, one or more portions of the high-stakes exam 115 (FIG. 1) may be stored on the boot-up control feature 440.

In another example (not shown), the boot-up control feature 440 may have its own processor. The boot-up control feature 440 may then be configured to scan the computing device 400 for programs which are being used by the computing device 400. If the boot-up control feature 440 determines that unauthorized programs are being used, the program can instruct the processor 410 to terminate the program and/or can make a note of the program that is being used.

In at least one example, managing the configuration of the computing device 400 may be an ongoing process. In particular, the computing device 400 may be synched with the educational management system 100 periodically. In such a case, the configuration of the computing device 400 may be monitored and/or updated during a synching process to thereby help ensure that the computing device 400 does not have unauthorized programs loaded. Such unauthorized programs may include programs used to cheat and/or to steal the high-stakes exam 115 (FIG. 1).

Referring again briefly to FIG. 2, once the configuration of the computing device has been managed, such as by controlling the boot-up process and/or by managing the configuration during synching processes, one or more aspect of the exam environment may be verified at step 240. Any number of aspects may be verified to establish trust between the computing device environment and an educational management system. Such aspects may include the configuration of the computing device 400 and in particular that the computing device 400 has been secured as described above at step 230. Verifying other aspects of the exam environment 40 may include verifying that the exam is being administered in the right location, such as by verifying a network connection used by the network interface 430 either implicitly or explicitly. Implicitly verifying a network connection may include providing the exam on a local area network or local wireless connection in which the user is able to take the exam while in communication with the network and unable to take the exam while not in communication with the network. Explicitly verifying the network connection may include a verification of a machine address or other identifier unique to a network or network location.

The location may also be verified by requiring a password, known only to a teacher or proctor to be entered. Or, it might require the presence of an additional security device such as a smart card or secure USB key. Some secure environments may make use of two or more factors such as a smart card and a password. Likewise, such environments may use those factors to directly secure the master key required to decrypt the exam.

In addition to verifying details regarding the computing device, the educational management system 100 may also be configured to verify the identity of the user taking the high-stakes exam 115 (FIG. 1). For example, one or more characteristic unique to each user, such as fingerprints, other biometric data or other characteristic may be ascertained before the exam and then verified at the time of exam.

Once the computing device has been verified, at step 250 the key 175 (FIG. 1) is sent to the computing device 400. As previously introduced, the key 175 may include several parts, including a parts list, one or more public keys, and a master key. Control of both the section keys and the master key may be used to reduce unauthorized use of the encrypted high-stakes exam 170.

As illustrated in FIG. 4, the master private key 330 may be distributed over a secure channel to one or more testing locations, such as to a proctor at the testing location. The section key 320a may be provided with the boot-up control feature 440. As previously introduced, the encrypted high-stakes exam 170 may include several parts which are encrypted using section keys, a list of the parts, and a master key for unlocking the parts list to allow access to the encrypted parts.

The master key 330 may be distributed to each member of a selected group, such as a group of examinees, class, a discussion group, or other selected group. In one example, the private master key 330 may be distributed as a password. The password may be distributed by a proctor or other user at the exam environment to allow distributed users to access the encrypted high-stakes exam 170. The master key 330 allows users to access open the encrypted educational content by allowing access to the parts list. However, the content within the encrypted high-stakes exam 170, such as each of the parts discussed above is encrypted with a part encryption key, which is in turn secured by a corresponding section key.

The unlocked section key or keys 320a may then be used to decrypt a portion or the entire encrypted high-stakes exam 170. In at least one example, when the section key 320a is removed, the encryption applied to the encrypted high-stakes exam 170 prevents further use of the encrypted high-stakes exam 170. As a result, although the encrypted high-stakes exam 170 may remain on the computing device 400, the encryption reduces the likelihood that the user will be able to make further use of the encrypted high-stakes exam without the master and section keys.

Once the section key 320a is accessible, the method continues at step 260 (FIG. 2) when the high-stakes exam 115 is administered on the secured and verified computing device 400. Administering the high-stakes exam 115 includes providing one or more questions or problems to the user and receiving responses to the problems or questions. It may be desirable to store the responses in a secure manner. In one example, the users' responses may be stored using a security feature 165 (FIG. 1), such as the boot-up control feature. The boot-up control feature 440 may include a memory device configured to store the user's responses to each question.

In another example, it may be desirable to send the responses to a remote location relative to the computing device 400, such as to the educational management system 100 (FIG. 1). The computing device 400 may use the network interface 440 to communicate the responses to the educational management system 100 over a secure channel. Further, the encryption features described above may also be used to send the responses. In other examples, the responses may be stored using any suitable process or device.

The responses are stored until administration of the high-stakes exam 115 is completed. Thereafter, the responses are scored at step 270. In another example, the responses may be scored on a response by response basis. The electronic format may allow some responses, such as multiple choice questions, to be scored quickly. The responses may be scored at any location using any number of scoring methods. Scoring the responses may include assigning a point value for each response.

Scoring the questions may further include making a determination about each user's performance. In particular, criteria may be established in advance for performance on the high-stakes exam 115, such as criteria relating to a number of points earned from the responses. For example, some high-stakes exams make use of a scale in which a raw score is assigned a point value. Other high-stakes exams include determining whether a user has displayed sufficient mastery of one or more subject areas. Accordingly, various criteria may be used to determine the student's performance.

Once the high-stakes exams have been scored, at step 280 the appropriate parties are notified. The parties may include the users 130a-n, the content provider 11, and/or other parties such as verification and certification authorities of the results. In one example, the notification provided to the users may include a certificate of completion, similar to those associated with courses that culminate in a high-stakes exam such as advanced placement courses or information technology courses. The verification and certification authorities may be able to authenticate the certificate because these authorities have also received a notification from the educational management system 100 of the results. One example of encrypted educational content is described in more detail below.

Embodiments of the present invention may include or be conducted using a special purpose or general-purpose computer, processor, or logic device including various computer hardware and devices, as discussed in greater detail herein or known to one of ordinary skill in the art. Embodiments within the scope of the present invention can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise RAM, ROM, EEPROM, CD-ROM or other optical disk storage, magnetic disk storage, other magnetic storage devices, or any other medium which can be used to carry or store desired program code means in the form of computer-executable instructions or data structures and which can be accessed by a general purpose computer, special purpose computer, or other logic devices.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the present invention. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, including an educational management system comprising a server, a method for administering a high-stakes exam, comprising:
securing at least one computing device having a processor and memory on which the high-stakes exam is to be administered by controlling the processor's access to the memory;
verifying at least one aspect of the environment in which the high-stakes exam is to be administered; and
administering the high-stakes exam on the computing device.

2. The method of claim 1, wherein controlling the processor's access to the memory includes booting the computing device from a computing device security feature.

3. The method of claim 2, wherein booting the computing device from the computing device security feature includes booting the computing device from a supplemental memory device.

4. The method of claim 3, wherein booting the computing device from the supplemental memory device includes booting the computing device from at least one of a USB drive, smart drive, optical storage media, and an additional hard drive.

5. The method of claim 1, wherein securing the processor's access to the memory includes loading an operating system from a supplemental memory device.

6. The method of claim 1, wherein the step of verifying at least one aspect of the environment in which the high-stakes exam is to be administered includes verifying at least one of a configuration of the computing device, a location of the computing device, and an identity of the user taking the high-stakes exam.

7. The method of claim 6, wherein verifying the location in which the high-stakes exam is to be administered includes verifying a network connection used the computing device.

8. The method of claim 1, further comprising a preliminary step of encrypting the high-stakes exam to provide an encrypted high-stakes exam and at least one key for decrypting the encrypted high-stakes exam.

9. The method of claim 8, further comprising a step of distributing the encrypted high-stakes exam to the computing device.

10. The method of claim 9, wherein the step of distributing the encrypted high-stakes exam includes distributing the encrypted high-stakes exam to one or more caching server and distributing the encrypted high-stakes exam from the caching server to the computing device.

11. The method of claim 9, further comprising distributing the key in a controlled manner to users.

12. In a computing environment, including an educational management system comprising a server, a method for administering high-stakes exams, the method comprising:
encrypting the high-stakes exam to form encrypted an encrypted high-stakes exam and at least one key for decrypting the encrypted high-stakes;
distributing the encrypted high-stakes exam to a computing device to the educational management system, and
verifying at least one aspect of an environment in which the computing device is to administer the high-stakes exam; and
distributing the key to the computing device.

13. The method of claim 12, wherein the step of encrypting the high-stakes exam includes packing the high-stakes exam into a cryptolope.

14. The method of claim 13, wherein the step of packing the high-stakes exam into a cryptolope further includes encrypting at least one part of the high-stakes exam with at least one part encryption key and a corresponding section key and at least one master list with a corresponding master key and wherein distributing the key includes distributing the section key and the master key.

15. The method of claim 14, wherein distributing the master key includes distributing a password at a testing location.

16. The method of claim 14, wherein distributing the section key includes storing the public key on a computing device security feature and distributing the computing device security feature to the computing device.

17. The method of claim 12, wherein the step of distributing the encrypted high-stakes exam to the computing device includes distributing the encrypted high-stakes exam to at least one caching server and distributing the encrypted high-stakes exam from the caching server to the computing device.

18. The method of claim 12, wherein the step of verifying at least one aspect of the environment in which the computing device is to administer the high-stakes exam includes verifying a configuration of the computing device.

19. The method of claim 12, wherein the step of verifying at least one aspect of the environment in which the computing device is to administer the high-stakes exam includes at least one of verifying the location of the computing device and the identity of the user.

20. A system for distributing and administering high-stakes exams in a computing environment, the system comprising:
an educational management system including a server and a database, the educational management system being configured to distribute high-stakes exams to a plurality of computing devices; and
a plurality of computing devices security features, the computing device security features being configured to control the operation of a computing device to secure the computing devices to prevent the computing devices from accessing unauthorized programs, the educational management system being configured to distribute the high-stakes exams to the computing devices, wherein the high-stakes exams are administered at least partially on the computing devices.

21. The system of claim 20, further comprising at least one caching server, the caching server being configured to receive the high-stakes exams from the educational management system and to distribute the high-stakes exams to the computing devices.

22. The system of claim 20, wherein the educational management system if configured to encrypt the high-stakes exam to form encrypted high-stakes exams and corresponding keys.

23. The system of claim 22, wherein the corresponding keys include at least one section key and at least one master key, the educational management system being configured to deliver the master key and the section key separately.

24. The system of claim 22, wherein the computing device security features are configured to deliver the section keys.
